(19) United States
(12) Patent Application Publication
(10) Pub. No.: US 2026/0105055 A1
(43) Pub. Date: Apr. 16, 2026

(54) METHODS, APPARATUSES, AND COMPUTER-READABLE MEDIA FOR INTERPRETING A PROMPT OF A FOUNDATION MODEL

(71) Applicant: HUAWEI TECHNOLOGIES CO., LTD., Shenzhen (CN)

(72) Inventors: Shaowei Wang, Winnipeg (CA); Ximing Dong, Kingston (CA); Dayi Lin, Toronto (CA); Ahmed E. Hassan, Kingston (CA)

(21) Appl. No.: 18/964,179

(22) Filed: Nov. 29, 2024

Related U.S. Application Data
(60) Provisional application No. 63/705,867, filed on Oct. 10, 2024.

(51) Int. Cl. G06F 16/2457

(52) U.S. Cl. CPC G06F 16/24578

(57) ABSTRACT

A method for interpreting a prompt of a foundation model. An importance score of a prompt token of the foundation model is calculated for a current output token, the importance score relative to a set of importance scores of other tokens comprising an output importance score of a prior output token, the foundation model outputting a sequence of output tokens in response to a prompt, the prompt comprising the prompt token, the sequence of output tokens comprising the prior output token and the current output token, the prior output token occurring before the current output token in the sequence of output tokens. The importance score of the prompt token is normalized relative to the set of importance scores excluding the output importance score. A cumulative importance score of the prompt token is calculated based on the normalized importance score.

### FIELD OF THE DISCLOSURE

The present disclosure relates generally to methods, apparatuses, and computer-readable storage media for interpreting a prompt of a foundation model, and in particular to methods, apparatuses, and computer-readable storage media for providing token-level explanations of prompts for foundation models, such as language models and large language models.

### BACKGROUND

Explanation techniques for machine learning models are an important area of research given the black box nature of machine learning models. Such machine learning explanation techniques may assist users in understanding the reasoning behind a decision, prediction, or other output of a machine learning model. One objective of machine learning explanation techniques is to improve the transparency of machine learning models. Existing explanation techniques include network analysis, sequential saliency, perturbation, and masking. These known explanation techniques have a number of limitations. For example, they are designed for classification and regression tasks, which output a single categorical or numerical value. The existing explanation techniques are not applicable to foundation models, such as language models (LMs) or large language models (LLMs), which generate sequential output (that is, a sequence of tokens).

### SUMMARY

According to one aspect of this disclosure, there is provided a method for interpreting a prompt of a foundation model. The method comprises calculating an importance score of a prompt token of the foundation model for a current output token, the importance score relative to a set of importance scores of other tokens comprising an output importance score of a prior output token, the foundation model outputting a sequence of output tokens in response to a prompt, the prompt comprising the prompt token, the sequence of output tokens comprising the prior output token and the current output token, the prior output token occurring before the current output token in the sequence of output tokens. The method further comprises normalizing the importance score of the prompt token relative to the set of importance scores excluding the output importance score to generate a normalized importance score of the prompt token. The method further comprises calculating a cumulative importance score of the prompt token based on the normalized importance score, for interpreting the prompt of the foundation model.

In some embodiments, the foundation model may be a language model or a large language model.

In some embodiments, said calculating the cumulative importance score of the prompt token may comprise aggregating a plurality of importance scores of the prompt token comprising the normalized importance score.

In some embodiments, said calculating the importance score of the prompt token may comprise calculating the importance score of the prompt token based on a local deep learning explanation method.

In some embodiments, the method may further comprise displaying the cumulative importance score of the prompt token on a display device.

In some embodiments, the method may further comprise multiplying the normalized importance score by a weighting factor before calculating the cumulative importance score. The weighting factor may be a further importance score. The weighting factor may be the further importance score of an output token of the foundation model. The weighting factor may be the further importance score of the current output token.

In some embodiments, the weighting factor may be a confidence score generated by the foundation model related to generating an output token.

In some embodiments, the prompt may be a structured prompt comprising a plurality of sub-prompts, each sub-prompt of the plurality of sub-prompts may be separated by at least one output token.

In some embodiments, the normalized importance score may be calculated based on the following formula:

$$\frac{X ( p\_ki , o\_uj )}{{\sum }_{m \leq j} {\sum }_{p \_ km ∈ p \_ m} X ( p\_km , o\_uj )}$$

where p_ki denotes a k^{th} token in an i^{th} sub-prompt, o_uj is a u^{th} token of a j^{th} output, and X is a function representing the deep learning explanation method.

In some embodiments, the cumulative importance score may be calculated based on the following formula:

$$\frac{{\sum }_{j \geq i} {\sum }_{1 \leq u \leq \vert output \_ j \vert} ( normalizedscore ( p\_ki , o\_uj ) * weight ( o\_uj ) )}{{\sum }_{j \geq i} \vert output\_j \vert}$$

where p_ki denotes a k^{th} token in an i^{th} sub-prompt, o_uj is a u^{th} token of a j^{th} output, and |output_j| is a token size of the j output.

In some embodiments, the local deep learning explanation method may be a sequential input explanation method. In some embodiments, the local deep learning explanation method may be gradient based. In some embodiments, the local deep learning explanation method may be perturbation based.

In some embodiments, the method may further comprise calculating a group importance score for a prompt grouping comprising the prompt token and at least one other prompt token by summing the cumulative importance score of the prompt token and at least one other cumulative importance score of the at least one other prompt token. The prompt grouping may be a word, a sentence, or a paragraph.

In some embodiments, the method may further comprise displaying the cumulative importance score in an integrated development environment for developing foundation models.

According to one aspect of this disclosure, there is provided a non-transitory computer-readable medium comprising computer program code stored thereon for interpreting a prompt of a foundation model, wherein the code, when executed by one or more processors, causes the one or more processors to perform the above-described method.

According to one aspect of this disclosure, there is provided a computing device comprising one or more processors operable to perform the above-described method for interpreting a prompt of a foundation model.

According to one aspect of this disclosure, there is provided a computer-implemented method for interpreting a prompt of a foundation model. The method comprises obtaining one or more first scores for each output token of a plurality of output tokens generated by the foundation model using one or more input tokens for forming an output in response to the prompt, each of the one or more first scores being related to one of the one or more input tokens and indicating an importance thereof in generating the corresponding output token, and each input token being one of a plurality of prompt tokens of the prompt or a prior output token of the plurality of output tokens generated prior to the output token. The method further comprises for each output token generated using one or more prompt tokens and one or more prior output tokens, normalizing the one or more first scores of the one or more prompt tokens with respect to an ensemble of the one or more prompt tokens. The method further comprises calculating a second score for each prompt token based on one or more of the normalized first scores related to the prompt token, for indicating an importance of the prompt token in forming the output, for interpreting the prompt in the formation of the output.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

The above-described methods, device, and one or more non-transitory computer-readable storage devices provide a number of advantages. For example, providing instance-level prompt explanation for LLMs. Providing easy debugging of prompts. Providing interpretation of prompts at different levels of granularity. Providing prompt explanation for more complex and structured prompts. Providing integration with a variety of DL explanation methods.

### BRIEF DESCRIPTION OF THE DRAWINGS

For a more complete understanding of the disclosure, reference is made to the following description and accompanying drawings, in which:

FIG. 1 is a schematic diagram of a computer network system for interpreting a prompt of a foundation model, according to some embodiments of this disclosure;

FIG. 2 is a schematic diagram showing a simplified hardware structure of a computing device of the computer network system shown in FIG. 1;

FIG. 3 a schematic diagram showing a simplified software architecture of a computing device of the computer network system shown in FIG. 1;

FIG. 4 is a flow diagram of a method performed by the computer network system shown in FIG. 1 for interpreting a prompt of a foundation model, according to some embodiments of this disclosure;

FIG. 5 is a flow diagram of a method performed by the computer network system shown in FIG. 1 for interpreting a prompt of a foundation model, according to some embodiments of this disclosure;

FIG. 6 is a flow diagram of a method performed by the computer network system shown in FIG. 1 for interpreting a prompt of a foundation model, according to some embodiments of this disclosure;

FIG. 7 is a schematic diagram of a method performed by the computer network system shown in FIG. 1 for interpreting a prompt of a foundation model, according to some embodiments of this disclosure; and

FIG. 8 is an output of a graphical user interface of the computer network system shown in FIG. 1 for interpreting a prompt of a foundation model, according to some embodiments of this disclosure.

### DETAILED DESCRIPTION

Embodiments disclosed herein may relate to a prompt explanation module or circuitry for executing a prompt explanation process.

As will be described later in more detail, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As will be described in more detail below, the prompt explanation module may be a part of a device, an apparatus, a system, and/or the like, wherein the prompt explanation module may be coupled to or integrated with other parts of the device, apparatus, or system such that the combination thereof forms the device, apparatus, or system. Alternatively, the prompt explanation module may be implemented as a standalone device or apparatus.

The prompt explanation module executes a prompt explanation process for interpreting the prompt of a foundation model. Herein, a process has a general meaning equivalent to that of a method, and does not necessarily correspond to the concept of computing process (which is the instance of a computer program being executed). More specifically, a process herein is a defined method implemented using hardware components for processing data (for example, prompt tokens of a foundation model, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the prompt explanation process disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. The prompt explanation module may read the computer-executable code from the storage devices and execute the computer-executable code to perform the processes.

Alternatively, the prompt explanation process disclosed herein may be implemented as one or more hardware structures having necessary electrical and/or optical components, circuits, logic gates, integrated circuit (IC) chips, and/or the like.

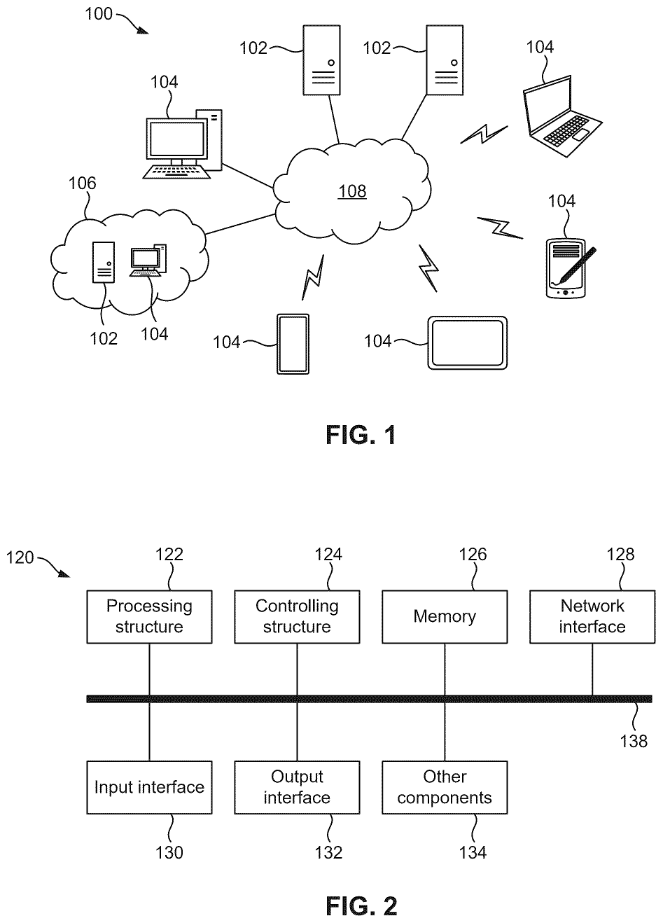

Turning now to FIG. 1, a computer network system for interpreting a prompt of a foundation model is shown and is generally identified using reference numeral 100. In these embodiments, the prompt explanation system 100 is configured for interpreting a prompt of a foundation model.

As shown in FIG. 1, the prompt explanation system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting as server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure 120 shown in FIG. 2. As shown, the hardware structure 120 comprises a processing structure 122, a controlling structure 124, one or more non-transitory computer-readable memory or storage devices 126, a network interface 128, an input interface 130, and an output interface 132, functionally interconnected by a system bus 138. The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI© (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

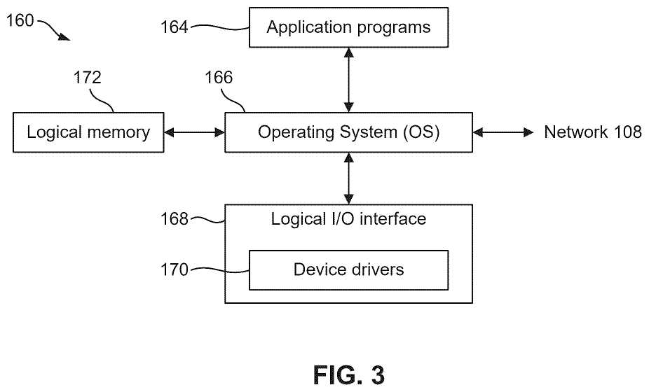

FIG. 3 shows a simplified software architecture 160 of the computing device 102 or 104. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 of the prompt explanation system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the prompt explanation system 100 may have the potential to perform various tasks, it cannot perform any tasks and is of no use without meaningful firmware and/or software. As will be described in more detail later, the prompt explanation system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

Throughout the present disclosure, the terms language model (LM), large language model (LLM), and foundation model (FM) may be used interchangeably. An FM is any type of advanced, large artificial intelligence (AI) or deep learning (DL) model. LMs and LLMs are types of FMs that take sequences of text as input and output sequences of text in response. FMs may be based on a transformer architecture, which takes a text sequence as input or prompt and outputs a text sequence.

LLMs can be effective for accomplishing a wide variety of tasks. A prompt is the user input or instruction to an LLM. More specifically, a prompt may be a sequence of text provided as input to the LLM by a user. The prompt guides the LLM to output desired content (that is, sequential output). Understanding how an LLM makes a decision and interprets a prompt may effectively help users to debug and improve the prompt. This is sometimes referred to as prompt engineering. Such tools may be included as part of integrated development environments (IDEs) for the development of LLMs. As LLMs are used with greater frequency, the importance of prompt explanation and interpretation becomes increasingly important. Prompt explanation and interpretation may comprise assisting users in understanding the reasoning behind a decision, prediction, or other output of an LLM. Prompt explanation and interpretation may comprise, for example, identifying the contribution of each input token of the prompt to the output generated by the LLM. Moreover, regulation of machine learning and artificial intelligence may require prompt explanation and interpretation. For example, Article 13 of the EU AI Act, states “High-risk AI systems shall be designed and developed in such a way to ensure that their operation is sufficiently transparent to enable users to interpret the system's output and use it appropriately.”¹ https://www.euaiact.com/key-issue/5#.

Due to the “blackbox” nature of the DL models and the importance of prompt explanation, a number of prompt explanation approaches have been developed for DL models that take sequential input data. One family of techniques is called network analysis, which examines the learned weights of the DL model. Typically, such weight analysis only examines the first layer of the DL model, because this is the layer where there is a direct interaction with the raw data inputs. Another family of techniques is called sequential saliency, which are designed to visualize sub-patterns of an input sequence that most contributed to the overall sequential representation used for final model prediction in a supervised learning environment. For instance, gradient-based approaches compute the gradient of the output layer with respect to the input layer to determine the relative importance of each element of input sequence. Both network analysis and sequential saliency require access to the model (for example, network analysis requires access to the neurons in the network). Another family of techniques is called perturbation, in which the input sequence is perturbated or masked and the difference between the original output and modified output is estimated to reflect the importance of the perturbated/masked elements in the input sequence.

Little research has been done on prompt explanation for LLMs specifically. Existing explanation techniques for DL models are mostly designed for classification and regression tasks, which only output a single categorical or numeric value. By contrast, LLMs generate a sequential output (that is, a sequence of tokens) based on an input prompt. The existing techniques are therefore not applicable to LLMs due to the different form of output.

Recent prompt explanation techniques are based on perturbation and masking of input words and then measuring their influence on output. There are a number of limitations to this approach. The time complexity of the perturbation-based approach is linear to the length of the prompt. In real-world scenarios, where prompts may be lengthy, this linear time complexity could render perturbation-based approaches impractical due to computational constraints and increased processing times. Perturbation-based approaches require users to define metrics to measure the influence of original and changed outputs. Determining suitable metrics to accurately assess the impact of prompt modifications may be non-trivial and may vary depending on the specific task or application. This challenge introduces a barrier to adoption for users who may lack the expertise or resources to devise appropriate evaluation criteria. Existing perturbation-based approaches primarily focus on word-level importance, overlooking the importance of explanation at different granularities within the prompt. Prompts often consist of various elements such as instructions, demonstration examples, or persona details, each contributing differently to the model's understanding and output. Neglecting these granularities may lead to incomplete or inadequate explanations, limiting the usefulness of prompt explanation techniques in real-world applications.

The present disclosure describes a prompt explanation system referred to as PromptExp for LLMs. PromptExp provides instance level interpretation for LLMs. Given a structured prompt and an LLM, PromptExp provides an importance score for each prompt token. The prompt may be the input of the LLM comprising one or more prompt tokens. A prompt token is a single unit of the prompt, such as a character, word, or group of characters or words. An output token is a single unit of the output of the LLM, such as a character, word, or group of characters or words. The prompt may be a structured prompt comprising a plurality of sub-prompts, each sub-prompt of the plurality of sub-prompts separated by at least one output token. For convenience, the structured prompt may be denoted as follows: P=p_1, [output_1], p_2, [output_2], . . . , p_i, [output_i], . . . , p_n [output n], where p_i is the ith sub-prompt, output_i is the ith output to be filled by the LLM, and n is the number of sub-prompts. The kth token in sub-prompt pi may be denoted as p_ki, An example of a structured prompt is the following: “Info about US basketball team [[output1=o_11, o_21]]. List the player name [[output2=o_12, o_22, o_32]].” PromptExp returns the importance score of each p_ki which represents the token's contribution to the LLM's output. The importance score may be represented by a number, such as a percentage or a decimal number between 0 and 1. A higher importance score indicates that the prompt token has a greater influence on the output. The importance scores of all the prompt tokens in a single round of token generation may sum to 100% or to 1, such that they indicate a relative importance relative to one another. A simple prompt comprising a single prompt and a single output is a special case of the above structured prompt. PromptExp may be applied to simple prompts as well. Users may enter into dialogues with LLMs, with the LLM responding to user prompts and the user responding to LLM outputs. A structured prompt may therefore comprise a plurality of sub-prompts and outputs.

LLMs output tokens one by one. The LLM produces a token in each round until certain criteria are satisfied (for example, generating a stop token or reaching the maximum number of tokens). Existing DL explanation techniques (such as sequential saliency) are designed for tasks that produce single output tokens (for example, classification or regression). To take advantage of existing DL explanation techniques, PromptExp aggregates the token importance scores generated by existing DL explanation techniques for each round of token generation. The process of PromptExp is divided into two stages. In Stage 1, PromptExp uses existing explanation methods (such as sequential saliency) to compute the importance scores of prompt tokens across each round of token generation. By applying these methods to each round individually, PromptExp generates importance scores for prompt tokens throughout the token generation process. In Stage 2, the token importance scores generated from all rounds are aggregated. These aggregated scores represent the cumulative importance of prompt tokens across all rounds of token generation. By aggregating the importance scores from multiple rounds, PromptExp provides a comprehensive evaluation of the significance of each token within the structured prompt. These aggregated scores are then considered as the final or cumulative token importance of the structured prompt. This two-stage process enables a comprehensive understanding of the significance of each token within the prompt, facilitating insightful analysis and interpretation for users.

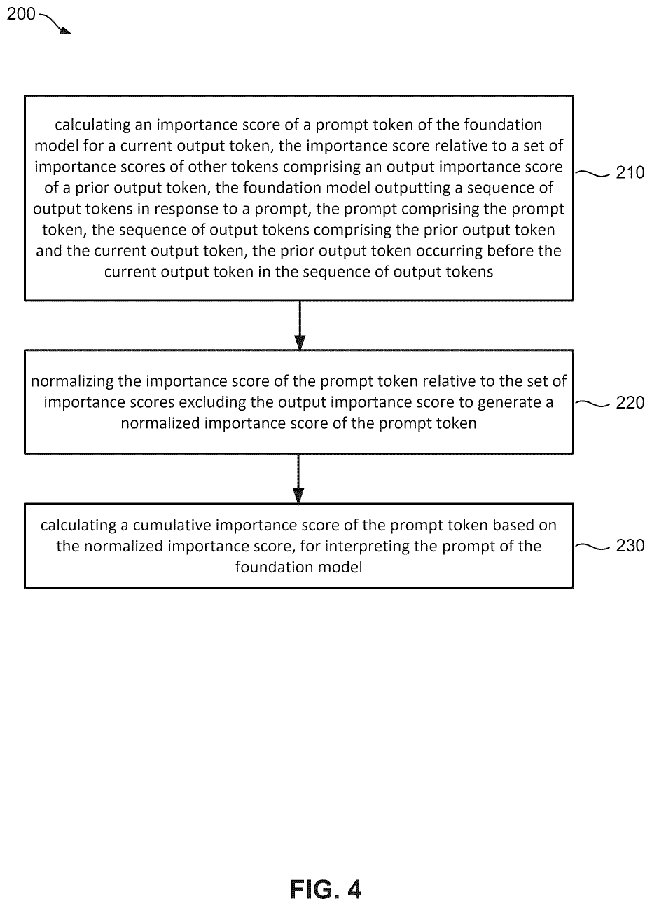

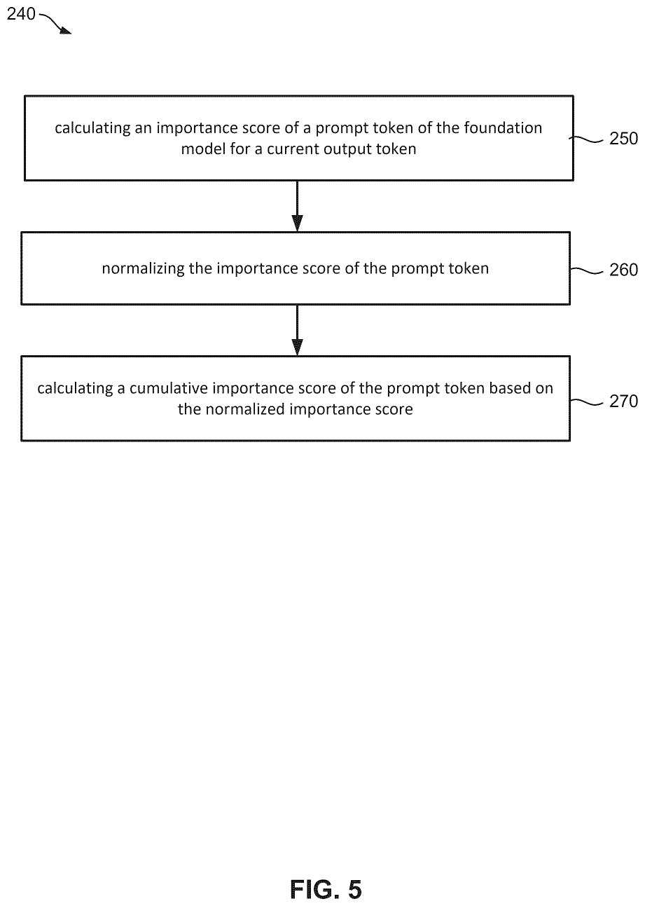

FIG. 4 shows a computer-implemented method 200 for interpreting a prompt of a foundation model. The method 200 comprises calculating 210 an importance score of a prompt token of the foundation model for a current output token, the importance score relative to a set of importance scores of other tokens comprising an output importance score of a prior output token, the foundation model outputting a sequence of output tokens in response to a prompt, the prompt comprising the prompt token, the sequence of output tokens comprising the prior output token and the current output token, the prior output token occurring before the current output token in the sequence of output tokens. Reference is simultaneously made to FIG. 5, which shows a computer-implemented method 240 for interpreting a prompt of a foundation model. The method 240 comprises calculating 250 an importance score of a prompt token of the foundation model for a current output token. In Stage 1, PromptExp generates importance scores of tokens in a structured prompt by using an existing DL model explanation method, which will hereinafter be referred to as X. For each round of text generation (that is, for each output token), PromptExp produces the importance scores for the tokens in the prompt. For example, given the sub-prompt p1={p_11, p_12}, the LLM takes p1 as the input and generates two output tokens o_11, and o_21. For output token o_11, X generates an importance score for each of p_11 and p_12, such as 0.2 and 0.1, respectively. The importance scores may represent a relative importance. The importance score of 0.2 compared to 0.1 indicates that the token p_11 has greater importance than p_12 in generating the output token o_11. For generating the output token o_21, the prompt is {p_11, p_12, o_11}. X produces three importance scores for output token o_21. LLMs typically use earlier generated output tokens as input to the LLM for the generation of later output tokens. Output tokens generated by the LLM thus become input tokens to the LLM. As a result, DL explanation methods generate importance scores for such output tokens used as input tokens. The importance scores generated by the DL explanation method may be relative to the prompt input tokens and the earlier generated output tokens.

For convenience, X(p_i, o_i) may be used to denote the importance score for the ith token p_i in the prompt p, at the round of text generation o_i.

Gradient-based importance (for example, InputXGradient) may be used as the DL explanation method X. InputXGradient is effective in model explanation, time efficient, and model-agnostic. Any alternative DL explanation method may be used in PromptExp. The DL explanation method X may be a local deep learning explanation method.

The method 200 further comprises normalizing 220 the importance score of the prompt token relative to the set of importance scores excluding the output importance score to generate a normalized importance score of the prompt token. The method 240 further comprises normalizing 260 the importance score of the prompt token. In Stage 2, PromptExp aggregates the importance scores of each token produced by X from each round of text generation and returns it as the final or cumulative importance score for each token in the prompt. During or prior to aggregation, the importance scores for the prompt tokens may be normalized relative to the importance scores for the other prompt tokens, excluding the important scores for any earlier generated output tokens. PromptExp may only return the importance scores of prompt tokens. PromptExp may not return importance scores for any output tokens. LLMs typically provide earlier generated output tokens as input to the LLM for the generation of later output tokens. As a result, DL explanation methods when used with LLMs may generate importance scores for both the prompt tokens and the earlier output tokens. To obtain importance scores for the prompt tokens alone, the importance scores of the prompt tokens may be normalized relative to one another excluding any importances scores for the output tokens.

The method 200 further comprises calculating 230 a cumulative importance score of the prompt token based on the normalized importance score, for interpreting the prompt of the foundation model. The method 240 further comprises calculating 270 a cumulative importance score of the prompt token based on the normalized importance score. The cumulative importance score of a prompt token may be calculated as an aggregation of the normalized importance scores of the prompt token as calculated for each output token. The aggregation may be calculated as an average or using any other aggregation method for combining the normalized importance scores. A user may use the importance scores to interpret the prompt of the foundation model by determining the relative contribution of each of the prompt tokens of the prompt to the output.

The foundation model may optionally be a LM or an LLM. LMs and LLMs are types of foundation models. These terms are used interchangeably throughout the present disclosure.

The method 200 may further comprise displaying the cumulative importance score of the prompt token on a display device. For example, the cumulative importance score may be displayed in a graphical user interface (GUI) on a computer display or on a mobile device. The cumulative importance score may be displayed within an IDE for developing machine learning models.

The method 200 may further comprise multiplying the normalized importance score by a weighting factor before calculating the cumulative importance score. The contribution or importance of each generated output token to the total or final output may vary relative to the other output tokens. Certain output tokens may be more important than others. For example, if the task is to produce a sentiment label for a sentence and the output is “the sentence is positive”, the output token “positive” is more important than the other output tokens. If greater weight is given to the importance scores of the input tokens that are calculated for the output token “positive” than for the other output tokens, the cumulative importance scores may be more accurate. Different weights may be assigned to each round of token generation based on the importance of the output token generated. The weight for a particular round of token generation may be multiplied by the importance scores associated with that round of token generation when aggregating the importance scores into a cumulative importance score. The weighting factor may be a percentage, a fraction, or a decimal number between 0 and 1. The weighting factor may be an importance score. The weighting factor may be an importance score of an output token of the LLM. For example, the weighting factor for an output token may be the importance score of the output token calculated by X in the last round of text generation. Alternatively, the weighting factor for an output token may be a confidence score generated by the LLM related to generating the output token. The weighting factor may be an estimate of the contribution of the output token. The weighting factor may be the same for each round of token generation. For example, if there are n output tokens, the weighting factor may be 1/n for each round of token generation.

The normalized importance score may be calculated based on the following formula:

$$normalizedscore ( p\_ki , o\_uj ) = \frac{X ( p\_ki , o\_uj )}{{\sum }_{m \leq j} {\sum }_{p \_ km ∈ p \_ m} X ( p\_km , o\_uj )}$$

where p_ki denotes a kth token in an ith sub-prompt, o_uj is a uth token of a jth output, and X is a function representing the deep learning explanation method. For example, suppose the importance scores for p_11, p_21, and o_11 for the generation of o_21 are 0.16, 0.1, and 0.14, respectively. The normalized importance score for p_11 may be calculated as follows: normalizedscore(p_11, o_21)=(0.16)/(0.16+0.1)=0.62.

The cumulative importance score may be calculated based on the following formula:

$$Imp ( p\_ki , X ) = \frac{{\sum }_{j \geq i} {\sum }_{1 \leq u \leq \vert output \_ j \vert} ( normalizedscore ( p\_ki , o\_uj ) * weight ( o\_uj ) )}{{\sum }_{j \geq i} \vert output\_j \vert}$$

where p_ki denotes a kth token in an ith sub-prompt, o_uj is a uth token of a jth output, and |output_j| is a token size of the jth output.

The local deep learning explanation method may be any method for determining the importance scores of the prompt tokens for a single round of output token generation. The local deep learning explanation method may be a sequential input explanation method. The local deep learning explanation method may be gradient based. The local deep learning explanation method may be perturbation based.

The method 200 may further comprise calculating a group importance score for a prompt grouping comprising the prompt token and at least one other prompt token by summing the cumulative importance score of the prompt token and at least one other cumulative importance score of the at least one other prompt token. The prompt grouping may be a word, a sentence, or a paragraph. Users may specify the level of granularity of the prompt explanations. For example, prompt explanations may be provided at the level of word, sentence, paragraph, or prompt component (for example, instruction or examples) by summing up the importance scores of the corresponding tokens in the user-defined group. Users may define their desired granularity or groupings. More specifically, suppose a user has defined the following groupings or components C_defined={C_1, C_2, . . . , C_i, . . . C_m}, where C_i is the ith defined grouping or component, which is composed of tokens {p_1i, p_2i, . . . , p_ni}. The importance score for C_i may be computed as:

$$C\_i = {\sum }_{j \leq n} imp ( p\_ji , X )$$

The method 200 may further comprise displaying the cumulative importance score in an Integrated Development Environment (IDE) for developing LLMs. PromptExp may be integrated into IDEs or platforms used for developing LLM-based applications. By embedding PromptExp functionality directly into the development environment, developers may gain insights into how prompts influence LLM behavior, aiding in understanding and debugging of prompt-related issues. This integration allows developers to visualize the importance of individual tokens within prompts, identify potential biases or errors, and iteratively refine prompts to improve model performance. With PromptExp readily accessible within their development workflow, developers may streamline the process of building and refining LLM-based applications.

PromptExp may be used for prompt compression. For example, prompt compression may be useful in scenarios where LLM input windows are limited and do not support long contexts. By using PromptExp to measure the importance of tokens within prompts, developers may identify and prioritize certain tokens while excluding non-important tokens in order to compress the prompt. This compression process involves retaining important tokens based on their measured importance, thereby reducing the overall size of the prompt while preserving its essential elements. By compressing prompts in this manner, developers may overcome constraints imposed by LLM input limitations and maximize the effectiveness of the available context for model inference. This enables more efficient utilization of LLM resources and improves performance in applications where long contexts are not feasible.

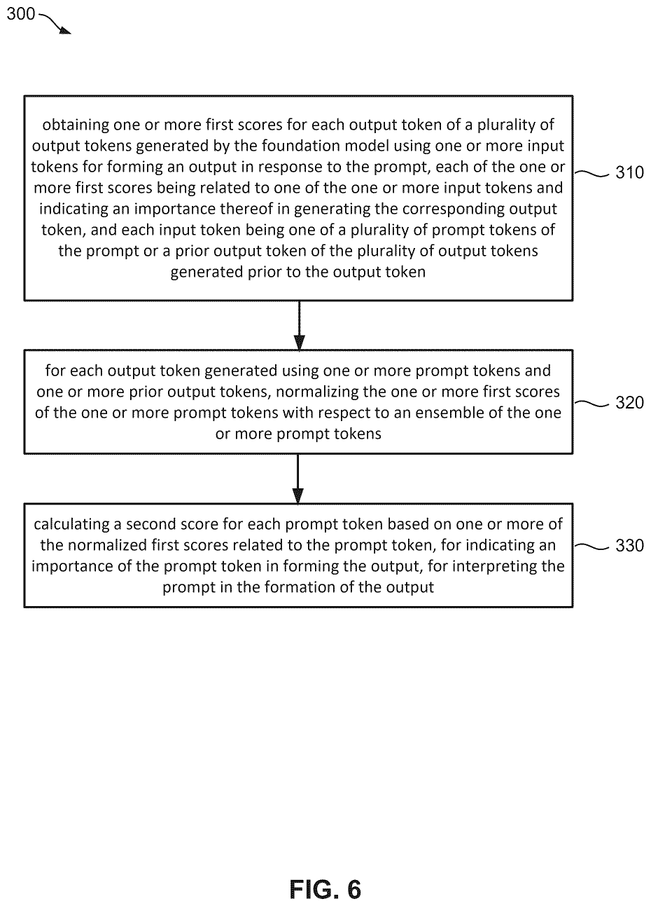

FIG. 6 shows a computer-implemented method 300 for interpreting a prompt of a foundation model. The method comprises obtaining 310 one or more first scores for each output token of a plurality of output tokens generated by the foundation model using one or more input tokens for forming an output in response to the prompt, each of the one or more first scores being related to one of the one or more input tokens and indicating an importance thereof in generating the corresponding output token, and each input token being one of a plurality of prompt tokens of the prompt or a prior output token of the plurality of output tokens generated prior to the output token.

The method 300 further comprises for each output token generated using one or more prompt tokens and one or more prior output tokens, normalizing 320 the one or more first scores of the one or more prompt tokens with respect to an ensemble of the one or more prompt tokens.

The method 300 further comprises calculating 330 a second score for each prompt token based on one or more of the normalized first scores related to the prompt token, for indicating an importance of the prompt token in forming the output, for interpreting the prompt in the formation of the output.

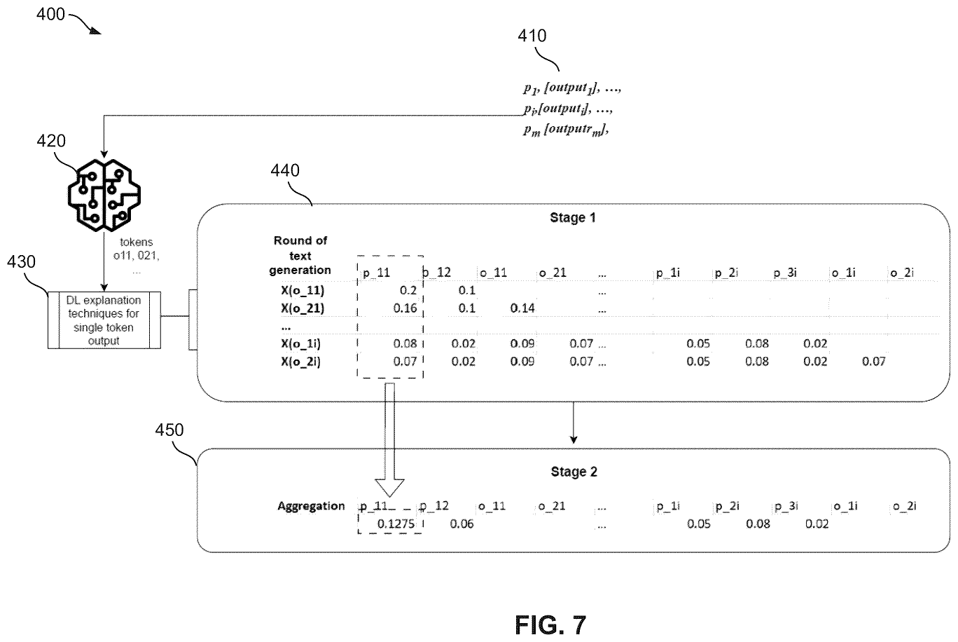

FIG. 7 shows a schematic diagram 400 of a method performed by the computer network system shown in FIG. 1 for interpreting a prompt of an LLM. The prompt input tokens 410 are provided to the LLM 420. The LLM 420 generates a number of output tokens. The prompt input tokens 410, the LLM 420, and the output tokens are provided to a DL explanation method 430. The DL explanation method 430 may be, for example, InputXGradient. In Stage 1, for each round of output token generation, the DL explanation method generates importance scores 440 for each of the prompt input tokens 410. In Stage 2, the plurality of importance scores 440 are aggregated into a single cumulative importance score 450 for each prompt input token 410. During or prior to aggregation, the importance scores for the prompt input tokens 410 may be normalized relative to the importance scores for the other prompt input tokens 410, excluding the important scores for any earlier generated output tokens. Aggregating the importance scores may also comprise weighting the importance scores using a weight factor.

Consider the following example of calculating the importance scores of prompt tokens. Suppose the prompt is as follows: “Info about US basketball team [[output1=o_11, o_21]]. list the player name [[output2=o_12, o_22, o_32]].” In Stage 1, the DL explanation method X may be used to calculate the importance scores for each of the prompt tokens for each round of text generation, as shown in Table 1 below:

TABLE 1
Stage 1 Importance Scores

| Round | info | about | US | basketball | team | o11 | o21 | . | list | the | player | name | o12 | o22 | o32 |
|---|---|---|---|---|---|---|---|---|---|---|---|---|---|---|---|
| X(o_11) | 0.2 | 0.1 | 0.25 | 0.35 | 0.1 | | | | | | | | | | |
| X(o_21) | 0.16 | 0.1 | 0.25 | 0.25 | 0.1 | 0.14 | | | | | | | | | |
| X(o_12) | 0.08 | 0.02 | 0.13 | 0.15 | 0.05 | 0.09 | 0.07 | 0.05 | 0.08 | 0.02 | 0.14 | 0.12 | | | |
| X(o_22) | 0.07 | 0.02 | 0.12 | 0.13 | 0.05 | 0.09 | 0.07 | 0.05 | 0.08 | 0.02 | 0.12 | 0.11 | 0.07 | | |
| X(o_32) | 0.07 | 0.02 | 0.11 | 0.12 | 0.05 | 0.09 | 0.07 | 0.05 | 0.08 | 0.02 | 0.11 | 0.1 | 0.06 | 0.05 | |

In Stage 2, the importance scores generated by X may be normalized, excluding any output tokens, as shown in Table 2 below:

TABLE 2
Stage 2 Normalized Importance Scores

| Round | info | about | US | basketball | team | o1 | o2 | . | list | the | player | name | o3 | o4 |
|---|---|---|---|---|---|---|---|---|---|---|---|---|---|---|
| X(o_11) | 0.20 | 0.10 | 0.25 | 0.35 | 0.10 | | | | | | | | | |
| X(o_21) | 0.19 | 0.12 | 0.29 | 0.29 | 0.12 | | | | | | | | | |
| X(o_12) | 0.10 | 0.02 | 0.15 | 0.18 | 0.06 | | | 0.06 | 0.10 | 0.02 | 0.17 | 0.14 | | |
| X(o_22) | 0.10 | 0.03 | 0.17 | 0.18 | 0.07 | | | 0.07 | 0.11 | 0.03 | 0.17 | 0.15 | | |
| X(o_32) | 0.10 | 0.03 | 0.16 | 0.18 | 0.07 | | | 0.07 | 0.12 | 0.03 | 0.16 | 0.15 | | |

Suppose weights for o_11, o_21, o_12, o_22, and o_32 are 0.2, 0.4, 0.2, 0.5, 0.6, respectively. The normalized importance scores may be aggregated to obtain a cumulative importance score for each prompt token. For example, the importance score for “basketball” may be calculated as [(normalizescore(basketball, o_11)*weight(o_11)+normalizescore(basketball, o_21)*weight(o_21) . . . +normalizescore(basketball, o_32)*weight(o_32)]/5=[0.35*0.2+0.29*0.4+0.18*0.2+0.18*0.5+0.18*0.6]/5=0.076.

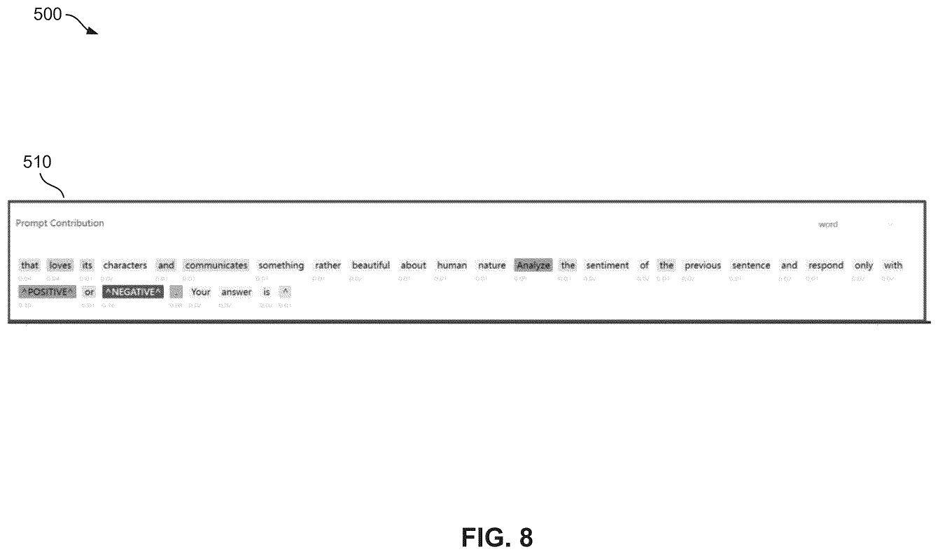

FIG. 8 shows an output 500 of a graphical user interface of the computer network system shown in FIG. 1 for interpreting a prompt of an LLM. The output 500 of the graphical user interface shows the importance scores associated with each of the prompt input tokens 510. This is just one way that the results of PromptExp may be presented to a user. As an alternative, the importance scores may be presented to the user as plots or charts (not shown).

Although embodiments have been described above with reference to the accompanying drawings, those of skill in the art will appreciate that variations and modifications may be made without departing from the scope thereof as defined by the appended claims.

1. A computer-implemented method for interpreting a prompt of a foundation model, the method comprising:
calculating an importance score of a prompt token of the foundation model for a current output token, the importance score relative to a set of importance scores of other tokens comprising an output importance score of a prior output token, the foundation model outputting a sequence of output tokens in response to a prompt, the prompt comprising the prompt token, the sequence of output tokens comprising the prior output token and the current output token, the prior output token occurring before the current output token in the sequence of output tokens;
normalizing the importance score of the prompt token relative to the set of importance scores excluding the output importance score to generate a normalized importance score of the prompt token; and
calculating a cumulative importance score of the prompt token based on the normalized importance score, for interpreting the prompt of the foundation model.

2. The method of claim 1, wherein the foundation model is a language model or a large language model.

3. The method of claim 1, wherein calculating the cumulative importance score of the prompt token comprises aggregating a plurality of importance scores of the prompt token comprising the normalized importance score.

4. The method of claim 1, wherein calculating the importance score of the prompt token comprises calculating the importance score of the prompt token based on a local deep learning explanation method.

5. The method of claim 1, further comprising displaying the cumulative importance score of the prompt token on a display device.

6. The method of claim 1, further comprising multiplying the normalized importance score by a weighting factor before calculating the cumulative importance score.

7. The method of claim 6, wherein the weighting factor is a further importance score.

8. The method of claim 7, wherein the weighting factor is the further importance score of an output token of the foundation model.

9. The method of claim 8, wherein the output token is the current output token.

10. The method of claim 6, wherein the weighting factor is a confidence score generated by the foundation model related to generating an output token.

11. The method of claim 1, wherein the prompt is a structured prompt comprising a plurality of sub-prompts, each sub-prompt of the plurality of sub-prompts separated by at least one output token.

12. The method of claim 11, wherein the normalized importance score is calculated based on the following formula:
$$\frac{X ( p\_ki , o\_uj )}{{\sum }_{m \leq j} {\sum }_{p \_ km ∈ p \_ m} X ( p\_km , o\_uj )}$$
where p_ki denotes a k^{th} token in an i^{th} sub-prompt, o_uj is a u^{th} token of a j^{th} output, and X is a function representing the deep learning explanation method.

13. The method of claim 11, wherein the cumulative importance score is calculated based on the following formula:
$$\frac{{\sum }_{j \geq i} {\sum }_{1 \leq u \leq \vert output \_ j \vert} ( normalizedscore ( p\_ki , o\_uj ) * weight ( o\_uj ) )}{{\sum }_{j \geq i} \vert output\_j \vert}$$
where p_ki denotes a k^{th} token in an i^{th} sub-prompt, o_uj is a u^{th} token of a j^{th} output, and |output_j| is a token size of the j^{th} output.

14. The method of claim 4, wherein the local deep learning explanation method is a sequential input explanation method.

15. The method of claim 4, wherein the local deep learning explanation method is gradient based.

16. The method of claim 4, wherein the local deep learning explanation method is perturbation based.

17. The method of claim 1, further comprising calculating a group importance score for a prompt grouping comprising the prompt token and at least one other prompt token by summing the cumulative importance score of the prompt token and at least one other cumulative importance score of the at least one other prompt token.

18. The method of claim 17, wherein the prompt grouping is a word, a sentence, or a paragraph.

19. The method of claim 1, further comprising displaying the cumulative importance score in an integrated development environment for developing foundation models.

20. A computing device comprising computer-readable memory storing instructions that, when executed by one or more processors, cause the one or more processors to perform a method for interpreting a prompt of a foundation model, wherein the method comprises:
calculating an importance score of a prompt token of the foundation for a current output token, the importance score relative to a set of importance scores of other tokens comprising an output importance score of a prior output token, the foundation model outputting a sequence of output tokens in response to a prompt, the prompt comprising the prompt token, the sequence of output tokens comprising the prior output token and the current output token, the prior output token occurring before the current output token in the sequence of output tokens;
normalizing the importance score of the prompt token relative to the set of importance scores excluding the output importance score to generate a normalized importance score of the prompt token; and
calculating a cumulative importance score of the prompt token based on the normalized importance score, for interpreting the prompt of the foundation model.

21. A computer-implemented method for interpreting a prompt of a foundation model, the method comprising:
obtaining one or more first scores for each output token of a plurality of output tokens generated by the foundation model using one or more input tokens for forming an output in response to the prompt, each of the one or more first scores being related to one of the one or more input tokens and indicating an importance thereof in generating the corresponding output token, and each input token being one of a plurality of prompt tokens of the prompt or a prior output token of the plurality of output tokens generated prior to the output token;
for each output token generated using one or more prompt tokens and one or more prior output tokens, normalizing the one or more first scores of the one or more prompt tokens with respect to an ensemble of the one or more prompt tokens; and
calculating a second score for each prompt token based on one or more of the normalized first scores related to the prompt token, for indicating an importance of the prompt token in forming the output, for interpreting the prompt in the formation of the output.
